(19) United States
(12) Patent Application Publication
(10) Pub. No.: US 2016/0098901 A1
(43) Pub. Date: Apr. 7, 2016

(54) WINNING GAME SYSTEM

(71) Applicant: TIEN-SHU HSU, Taichung City (TW)

(72) Inventor: TIEN-SHU HSU, Taichung City (TW)

(21) Appl. No.: 14/808,599

(22) Filed: Jul. 24, 2015

(30) Foreign Application Priority Data
Oct. 7, 2014 (TW) 103134847

(51) Int. Cl. G07F 17/32

(52) U.S. Cl. CPC G07F 17/3267; G07F 17/3209; G07F 17/3244

(57) ABSTRACT

A winning game system to allow a player to play and get a prize includes a user interface, an accumulation unit and a winning calculation payment unit. The user interface includes a plurality of selection buttons that can be picked by the player to display obtained items which include a plurality of prizes and at least one end prize. The winning game ends immediately when the end prize is picked by the player. The accumulation unit accumulates the prize picked by the player. After the end prize is picked by the player, the winning calculation payment unit, based on the accumulated prize got by the accumulation unit, calculates the winning and pays the player, thus provides excitement of unpredictable ending the winning game and increases the appeal of the winning game to the player.

### FIELD OF THE INVENTION

The present invention relates to a winning game and particularly to a winning game operation system.

### BACKGROUND OF THE INVENTION

Winning game is a game system that provides extra award. It is generated randomly or can enter after a certain condition set by the game system is met. It provides a feature like this: after entering the winning game a certain amount of winning can be granted free without additional betting, hence gives players a feeling of earning a prize, therefore can attract more players to play the game to increase system utilization.

The conventional winning game is a small game independent from the game system, and generally provides a fixed game time or game number to allow the players to play within the game time or game number to get scores, and finally convert the scores to get the payment of winning.

For the players the conventional winning game is merely a game played in another different method, and could feel too monotonous, hence is not very appealing. The players mainly look forward to get an extra prize, and could be not interested in playing. As a result, it cannot fully meet use requirements.

### SUMMARY OF THE INVENTION

Therefore the primary object of the present invention is to provide a winning game system that allows players to play a winning game through a lottery approach and can enjoy the excitement of unpredictable ending, hence increases the appeal to the players.

To achieve the foregoing object the invention provides a winning game system to allow a player to play and get a winning. It includes a user interface, an accumulation unit and a winning calculation payment unit. The user interface includes a plurality of buttons that can be picked by the player to display respectively an obtained item. The obtained items include a plurality of prizes and at least one end prize. In the event that the end prize is picked by the player, the winning game immediately ends. The accumulation unit accumulates the prize picked by the player. After the end prize is picked by the player, the winning calculation payment unit, based on the accumulated prize, calculates the winning and pays the player, thus increases the offered winning of the winning game, and also provides excitement of unpredictable ending of the winning game to make the winning game more appealing.

In practice, the prizes can be a plurality of extra prizes which include multiple prizes of different multiples or fixed amounts of extra prizes. The end prize can be at least one winning class prize which includes a plurality of winning prize classes. When the winning class prize is picked, the winning game immediately ends. When the player has picked the extra prizes the accumulation unit accumulates the values of the multiple prizes of varying multiples or the accumulated fixed amounts of the extra prizes. When the player has picked a winning class prize the winning calculation payment unit adds an extra amount of money to the winning class prize as the winning to pay the player. Moreover, the extra amount of money is the multiplication product of the value of the picked winning class prize and the value of prize multiples accumulated in the accumulation unit, or the fixed amounts of the extra prizes accumulated in the accumulation unit. When the extra prize includes both the prizes of varying multiples and the prize of fixed amounts of money of the extra prizes, the extra amount of money is the sum of the aforesaid multiplication product and the fixed amounts of money of the extra prize.

In another implementation approach the winning can be anyone selected from a plurality of winning class prizes. The winning class prizes can be divided into different classes according to the amount of money. The prizes can be a plurality of accumulation point options. The end prize can be an end button. The accumulation unit accumulates the values of the accumulation point option when the player has picked the accumulation point option. The winning calculation payment unit, upon the player has picked the end button, decides which class of the winning class prizes to be offered as the winning to the player based on the value of the accumulation point option accumulated in the accumulation unit.

Thus, through the invention the user interface provides multiple selection buttons to be freely picked by the player. Once picked, each selection button displays an obtained item.

The obtain items include a plurality of prizes and at least one end prize. When the end prize is picked, the winning game immediately ends. Hence the player can accumulate the prize until the end prize is picked. Therefore it is somewhat like playing lottery to give the player excitement without knowing when the winning game will end, thus can increase the appeal of the game to the player.

The foregoing, as well as additional objects, features and advantages of the invention will be more readily apparent from the following embodiments and detailed description, which proceed with reference to the accompanying drawings. The embodiments merely serve for illustrative purpose and are not the limitation of the invention.

### BRIEF DESCRIPTION OF THE DRAWINGS

FIG. 1 is a block diagram of system architecture of the invention.

FIGS. 2A through 2D are schematic views of a first embodiment of the user interface of the invention.

FIGS. 3A through 3D are schematic views of a second embodiment of the user interface of the invention.

FIG. 4 is a schematic view of another implementation approach of the second embodiment of the invention.

### DETAILED DESCRIPTION OF THE PREFERRED EMBODIMENTS

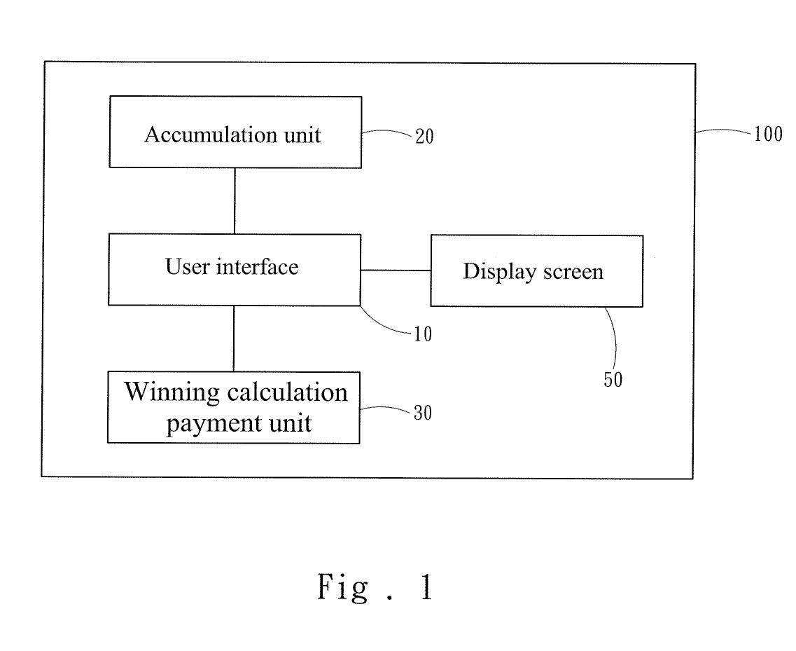

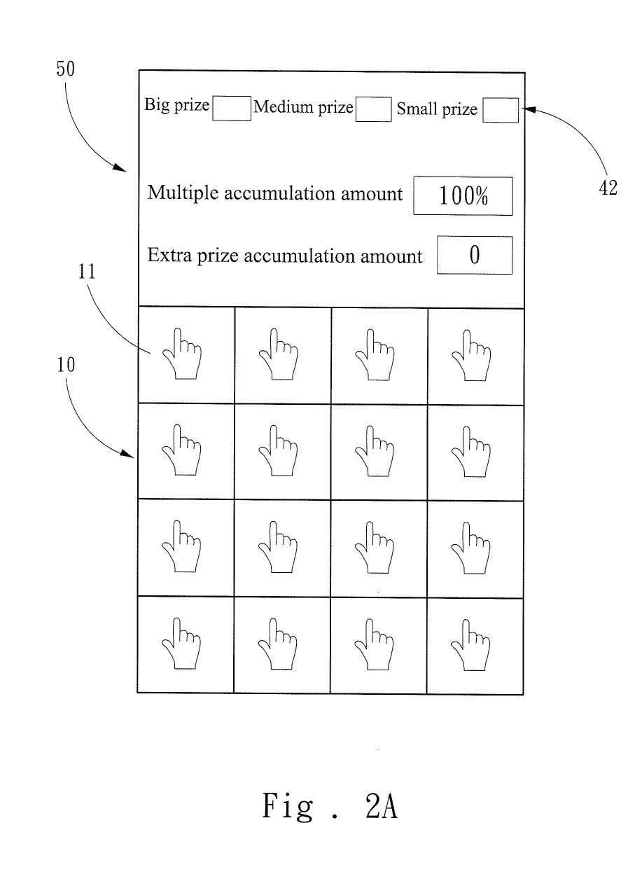

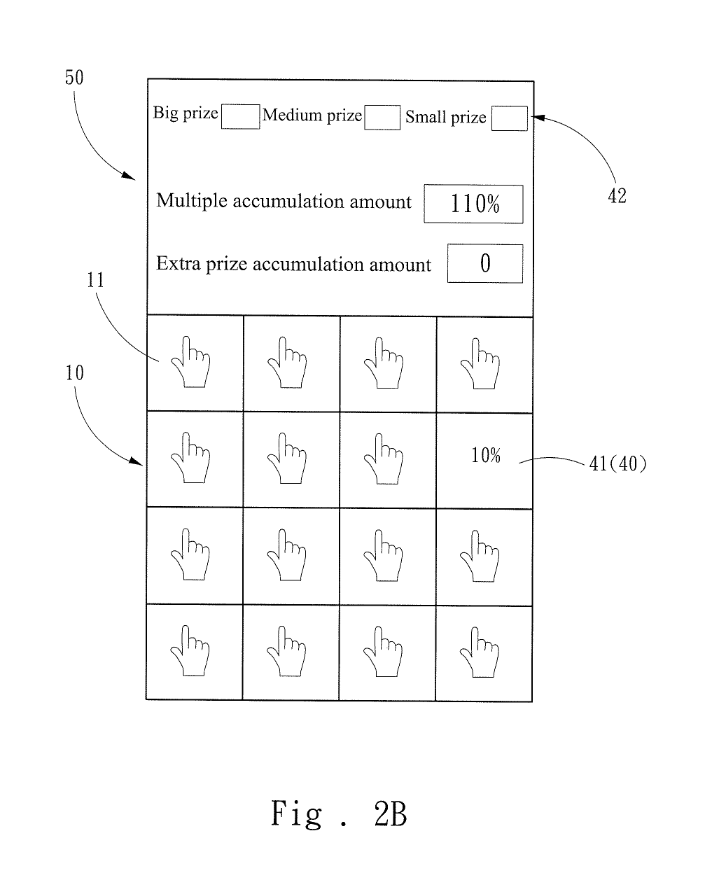

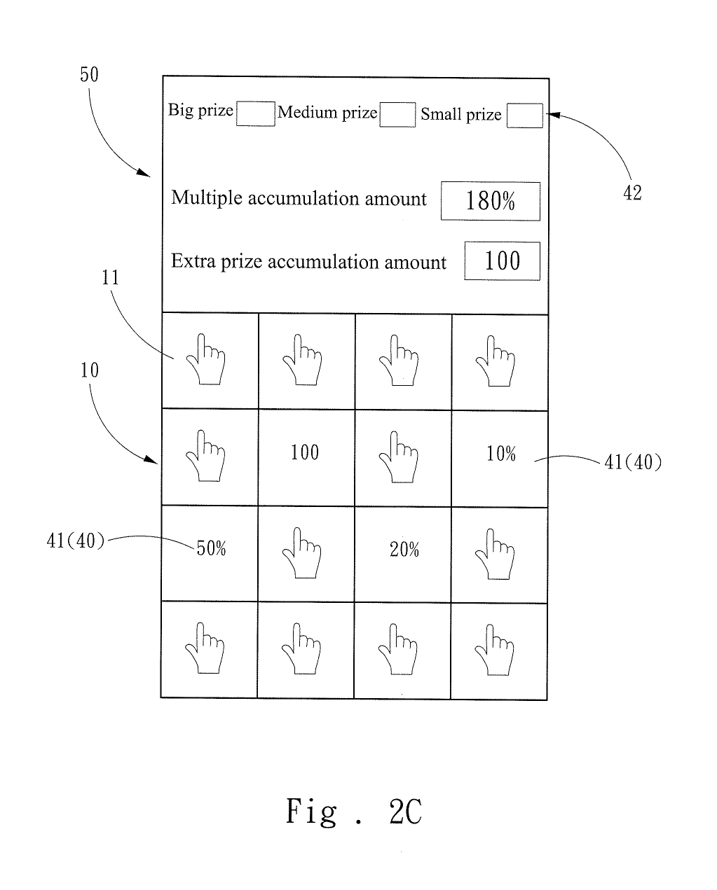

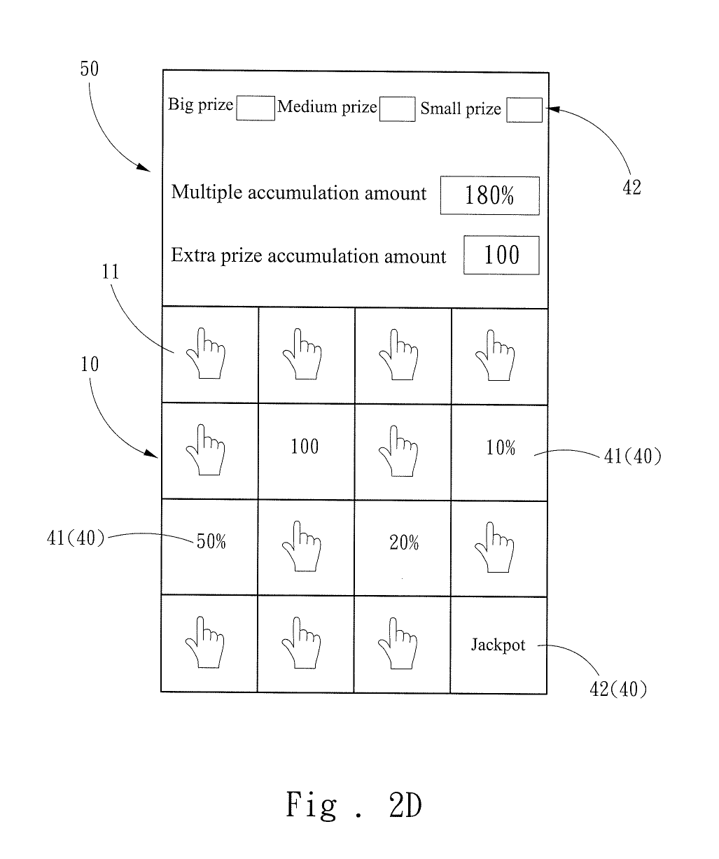

Please refer to FIGS. 1, and 2A through 2D for a first embodiment of the invention of a winning game system 100 that allows a player to play and get a winning. It includes a user interface 10, an accumulation unit 20 and a winning calculation payment unit 30. The user interface 10 includes a plurality of buttons 11 that can be picked by the player to display respectively an obtained item 40. The obtained items 40 include a plurality of extra prizes 41 and at least one winning class prize 42. The extra prizes 41 include multiple prizes of different multiples or fixed amounts of extra prizes. When the winning class prize 42 is picked, the winning game ends immediately. The user interface 10 can be physical buttons or a touch screen. The touch screen can directly display the outcome of the buttons being picked, hence is a preferred implementation approach.

The invention can further include a display screen 50 to display the value of the winning class prize 42. For instance, the winning class prize 42 can be divided into a big prize, a medium prize and a small prize with three different amounts of money.

When the player has picked the extra prizes 41 the accumulation unit 20 accumulates the value of the multiple prizes of varying multiples or the fixed amounts of extra prizes. The display screen 50 also displays the value of current accumulated amount of the multiples or the fixed amounts of extra prizes. The displayed value of the accumulated multiples includes the original 100%.

When the player has picked the winning class prize 42 the winning calculation payment unit 30 gives the player an extra amount of money in addition to the winning class prize 42 for the winning. The extra amount of money is the multiplication product of the value of the picked winning class prize 42 and the value of the prize multiples accumulated in the accumulation unit 20, or the fixed amounts of extra prizes accumulated in the accumulation unit 20. When the extra prize 41 includes both the prizes of varying multiples and the prize of the fixed amounts of extra prizes, the extra amount of money is the sum of the aforesaid multiplication product value and the accumulated amount of the fixed amounts extra prizes.

In this embodiment the different multiples of the multiple prizes of the extra prizes 41 can be made in a specific range, such as 10% to 100%, and be generated randomly, or be selected from an odds combination which includes numerals given in advance, such as 10%, 10%, 20%, 20%, 100%, or 10%, 20%, 30%, 40%, 50%, or the like.

During the winning game the player can freely pick any button 11 as desired, as shown in FIG. 2A, and the player might pick an extra prize 41 which allows continuous picking, or pick a winning class prize 42 which immediately ends the winning game. Please referring to FIG. 2B, if a multiple prize of 10% is picked, the accumulation unit 20 performs accumulation, hence the original 100% becomes 110% and is displayed, while the extra prize accumulation amount is 0. Referring to FIG. 2C, the player can continue picking, and has picked multiple prizes of 20% and 50%, and also an extra prize amount 100, then the multiple accumulation amount of 180% is displayed, and the extra prize accumulation amount of 100 also is displayed. Finally, referring to FIG. 2D, the display shows that a winning class prize 42 (jackpot) is picked, the winning calculation payment unit 30 makes calculation based on the multiple accumulation amount (80%) in the accumulation unit 20 and extra prize 100, and the winning class prize 42 (jackpot), and also adds an extra amount of money based on the winning class prize 42, i.e., the payment to the player is the sum of the multiplication product of the winning amount of the jackpot and 180%, and the extra prize accumulation amount 100.

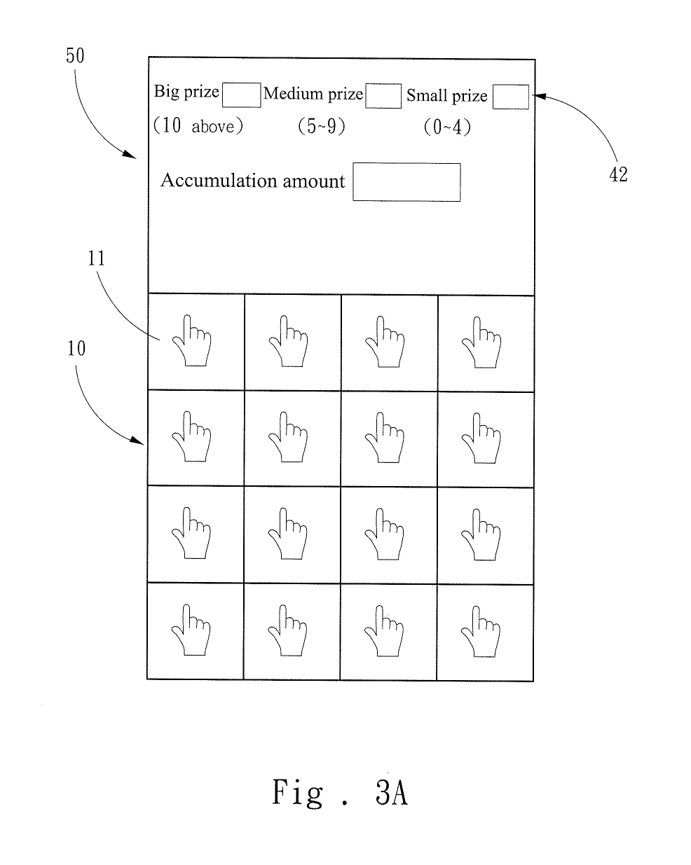

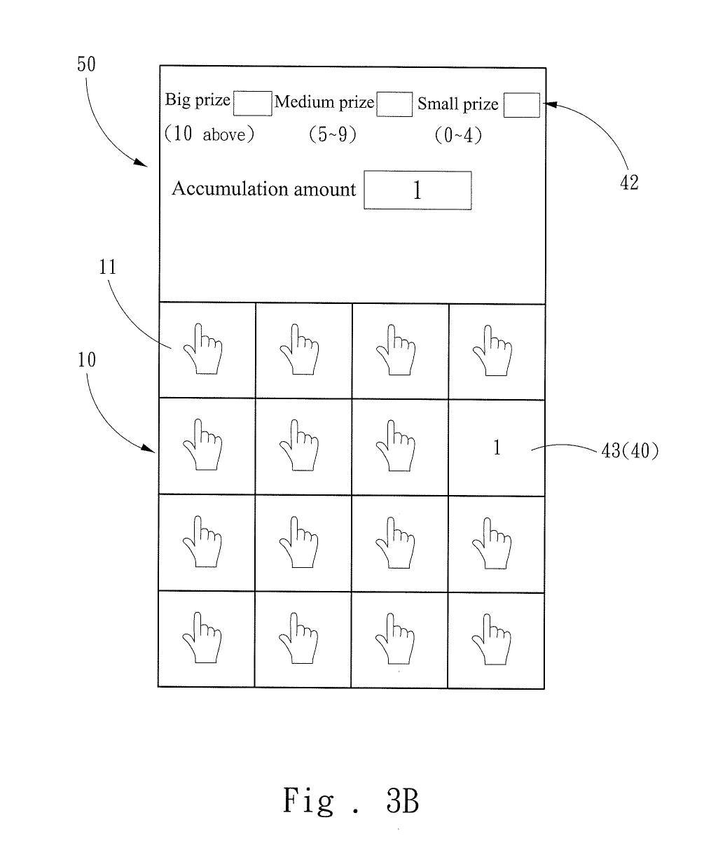

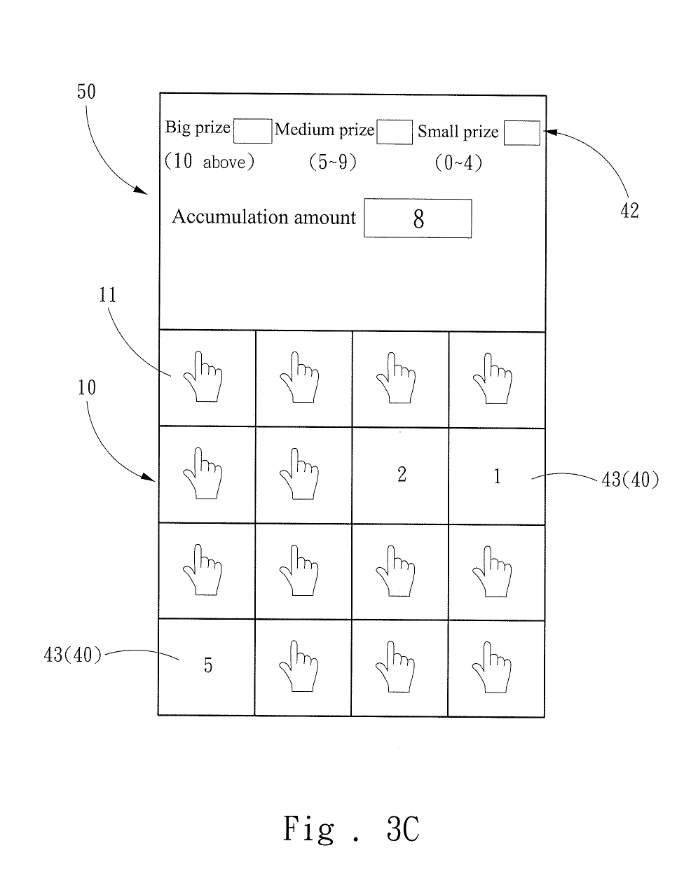

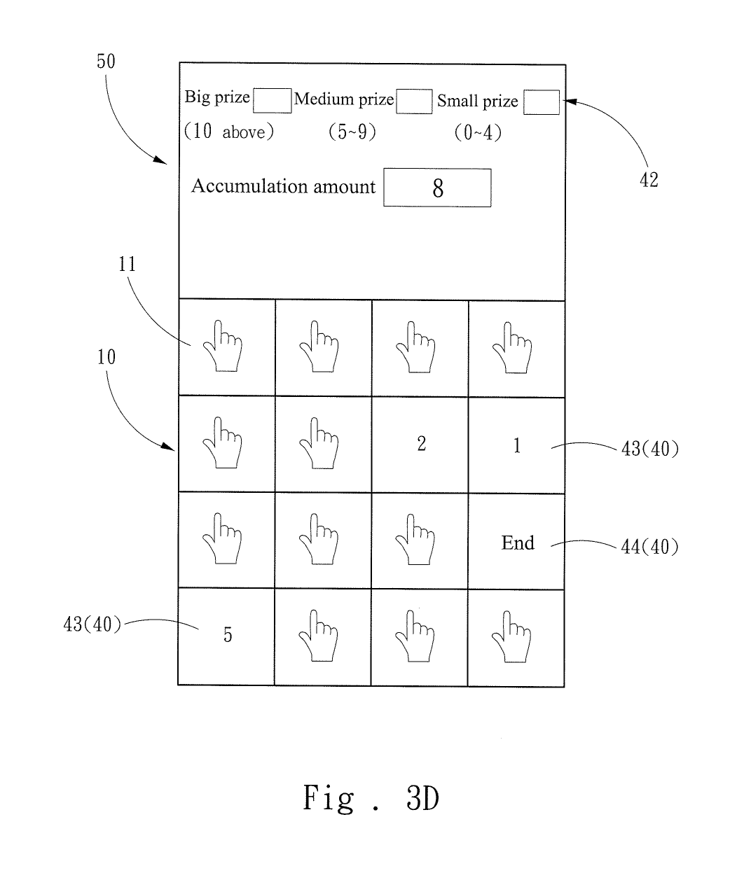

Please refer to FIGS. 1, and 3A through 3D for another embodiment of the invention. In this embodiment the winning is selected from anyone of a plurality of winning class prizes 42 which are divided into different classes according to money amounts. It also includes a user interface 10, an accumulation unit 20 and a winning calculation payment unit 30. The user interface 10 includes a plurality of buttons 11 that can be picked by the player to display respectively a prize 40. The prizes 40 include a plurality of accumulation point options 43 and an end button 44 to immediately end the winning game when picked. The user interface 10 can be physical buttons or a touch screen.

When the accumulation point options 43 are picked by the player their values are accumulated by the accumulation unit 20. When the player has picked the end button 44 the winning calculation payment unit 30, based on accumulated value of the accumulation point option 43 done by the accumulation unit 20, determines which class of the winning class prizes 42 to be selected for the winning to give the player.

Similarly, this embodiment can also include a display screen 50 to display the class of the winning class prizes 42 corresponding the value of the accumulation point options 43, namely, indicates which class of the winning class prizes 42 can be exchanged by the accumulated value of the accumulation unit 20. In general, it can be divided into three types of “Big Prize”, “Medium Prize” and “Small Prize” as shown in the drawings. For instance, the value of the accumulation point option 43 of the “Big Prize” can be 10 or more, the value of the accumulation point option 43 of the “Medium Prize” can be ranged from 5 to 9, and the value of the accumulation point option 43 of the “Small Prize” can be ranged from 0 to 4.

In addition, the value of the accumulation point option 43 also can be randomly generated from a specific range of values, such as between 1 and 5, or selected from a numeral combination from numerals given in advance, such as randomly selected from numeral combinations of 1,1,2,2,5.

Please referring to FIG. 3A, during the winning game the player can freely choose which button 11 to pick, it could be one of the accumulation point options 43, or the end button 44 to end the winning game. Referring to FIG. 3B, if an accumulation point option 43 is picked with a value of 1, the accumulation unit 20 accumulates the picked value. The player can continuously make the picking choice, such as pick other accumulation point options 43 with values of 2 and 5 in this order, and the accumulated value becomes 8. Finally, as shown in FIG. 3D, an end game button 44 is picked, and a “Jackpot” is generated, the winning calculation payment unit 30 immediately selects the value (i.e. 8) in the accumulation point option 43 accumulated by the accumulation unit 20 as the winning of the “Jackpot” to grant the player.

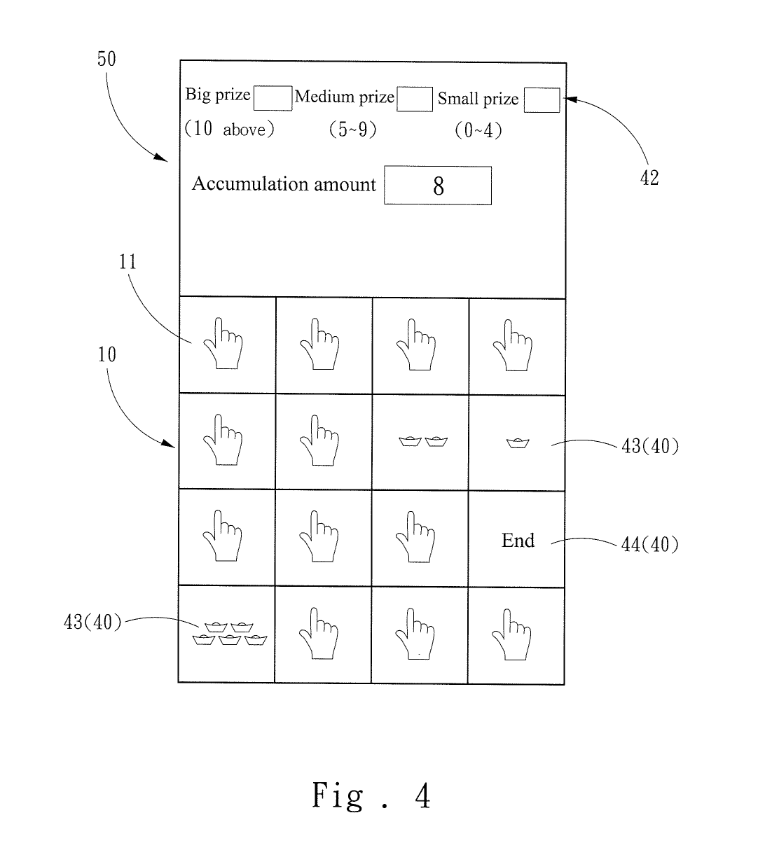

Please also referring to FIG. 4, in order to enhance visual effect and appeal of the interface, different values of the accumulation point options 43 can be indicated by different graphics, such as different numbers of gold ingots stacked together to represent the values. Therefore the player can figure out the value of the accumulation point options 43 by seeing the number of the stacked gold ingots.

As a conclusion, the invention, through the user interface equipped with a plurality of selection buttons, allows a player to freely pick the buttons. When a button is picked, it displays one of prizes that allows continuous picking or an end prize to immediately end the winning game. Namely, the player can accumulate the prizes until the end prize is picked, hence it is somewhat like lottery and can give the player excitement of an unpredictable result, therefore can increase the appeal to the player and also meet player's requirements.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A winning game system to allow a player to play and give the player a winning, comprising:
a user interface including a plurality of selection buttons selectable by the player to display obtained items which include a plurality of prizes and at least one end prize, when the end prize being selected the winning game ends immediately;
an accumulation unit to accumulate the prize selected by the player; and
a winning calculation payment unit to calculate the winning and give the winning to the player based on the prize accumulated by the accumulation unit when the end prize is selected.

2. A winning game system to allow a player to play and give the player a winning, comprising:
a user interface including a plurality of selection buttons selectable by the player to display obtained items which include a plurality of extra prizes and at least one winning class prize, the extra prizes including multiple prizes of different multiples, the winning class prize including winning prices of a plurality of classes, the winning game being ended immediately when the winning class prize is selected;
an accumulation unit to accumulate values of the multiple prizes of different multiples when the extra prizes are selected by the player; and
a winning calculation payment unit to add an extra amount of money to the winning in addition to the winning class prize when the winning class prize is selected by the player and give the winning to the player, the extra amount of money being a multiplication product of the value of the winning class prize being selected and the value of the multiple prizes of different multiples accumulated by the accumulation unit.

3. The winning game system of claim 2, wherein the user interface is selectively physical buttons or a touch screen.

4. The winning game system of claim 2 further including a display screen which displays the value of the winning class prize.

5. The winning game system of claim 2, wherein the values of the multiple prizes of different multiples are generated randomly within a selected range.

6. The winning game system of claim 2, wherein the values of the multiple prizes of different multiples are selected from an odds combination which is numerals given in advance.

7. A winning game system to allow a player to play and give the player a winning, comprising:
a user interface including a plurality of selection buttons selectable by the player to display obtained items which include a plurality of extra prizes and at least one winning class prize, the extra prizes including fixed amounts of extra prizes, the winning class prize including winning prices of a plurality of classes, the winning game being ended immediately when the winning class prize is selected;
an accumulation unit to accumulate values of the fixed amounts of extra prizes when the extra prizes are selected by the player; and
a winning calculation payment unit to add an extra amount of money to the winning in addition to the winning class prize when the winning class prize is selected by the player and give the winning to the player, the extra amount of money being the fixed amounts of extra prizes accumulated by the accumulation unit.

8. The winning game system of claim 7, wherein the user interface is selectively physical buttons or a touch screen.

9. The winning game system of claim 7 further including a display screen which displays the value of the winning class prize.

10. A winning game system to allow a player to play and give the player a winning, the winning being selected from anyone of a plurality of winning class prizes which are divided into different classes according to amounts of money thereof, comprising:
a user interface including a plurality of selection buttons selectable by the player to display obtained items which include a plurality of accumulation point options and at least one end button to end the winning game, the winning class prizes including winning prices of a plurality of classes, the accumulation point options including different values, the winning game being ended immediately when the end button is selected;
an accumulation unit to accumulate values of the accumulation point options that are selected by the player; and
a winning calculation payment unit to decide which class of the winning class prizes to be selected for the winning to give the player based on the value of the accumulation point options accumulated by the accumulation unit when the end button is selected by the player.

11. The winning game system of claim 10, wherein the user interface is selectively physical buttons or a touch screen.

12. The winning game system of claim 10 further including a display screen which displays the classes of the winning class prizes corresponding to the values of the accumulation point options.

13. The winning game system of claim 10, wherein the values of the accumulation point options are generated randomly from a selected range.

14. The winning game system of claim 10, wherein the values of the accumulation point options are selected from a numeral combination which is given in advance.

15. The winning game system of claim 10, wherein different values of the accumulation point options are indicated via graphics.
